(19) United States
(12) Patent Application Publication
(10) Pub. No.: US 2004/0118931 A1
(43) Pub. Date: Jun. 24, 2004

(54) Authentication of items using transient optical state change materials

(76) Inventors: Richard H. Selinfreund, Guilford, CT (US); Scott Gerger, Des Moines, IA (US); Peter Miller, New London, CT (US); Rakesh Vig, Durham, CT (US)

Correspondence Address: PILLSBURY WINTHROP, LLP, P.O. BOX 10500, MCLEAN, VA, 22102, US

(21) Appl. No.: 10/672,624

(22) Filed: Sep. 26, 2003

Related U.S. Application Data
(60) Provisional application No. 60/413,728, filed on Sep. 26, 2002.

(51) Int. Cl. G06K 19/06

(52) U.S. Cl. 235/492

(57) ABSTRACT

The use of transient optical state change security materials to authenticate items.

### BACKGROUND OF THE INVENTION

1. Field of the Invention

The present invention generally relates to transient optical state change security materials and their use to authenticate items.

2. Description of the Related Art

The need for authentication of products today is significant. Many products are worth far more than the cost of their component parts. For example, numerous electronic devices, software programs, purses, designer garments, etc. are sold for many times the cost actually involved in their production. Given the value of such devices, and the relatively low cost for producing them, there has become a large illegal counterfeit goods market. Protection against counterfeiting has traditionally encompassed the placement of fluorescent or phosphorescent materials, or surreptitiously hidden authenticity marks, on an item in a manner deemed to be difficult to detect by a would-be copyist. Unfortunately, experience has shown that not infrequently the security materials or marks are uncovered by the copyist and reproduced on the counterfeit good.

It is particularly difficult to detect counterfeit software programs and the illicitly-altered databases. The difficulty in detecting the same is greatly enhanced when the medium on which such software or databases are stored is authentic, but the program or database is not. For example, it is known to alter programming code in commercially-available software to introduce viruses or other programming code that allows one to surreptitiously gain access to other programs or databases on which such code is downloaded. It is also known for hackers to alter valid databases in order to alter facts for their own benefit. For example, hackers may enter bank statements to alter the amount of money attributed to their account.

It has been known in the art to store data on optical media in the form of optical deformations or marks placed at discrete locations in one or more layers of the medium. Such deformations or marks (“data deformations”) effectuate changes in light reflectivity. To read the data deformations on the medium, an optical player or “reader” is used. An optical reader often functions by shining a small spot of laser light, known as the “readout” spot, through a portion of the medium to the data layer containing such optical data deformations. Usually the medium in an optical reader or the laser head of the optical reader rotates or moves.

In conventional “read-only” optical media of the “optical disc” type (e.g., CDs, DVDs), data is generally encoded by a series of pits and lands that are metalized. A readout spot directed from the non-metalized side is reflected in a manner that the light of readout spot is reflected back into a photosensor in the reader. When referenced from the laser reading side, pits are technically referred to as bumps. The transitions between pits and lands, and the timing in between such transitions, represent channel bits. Thus the pit and lands in themselves are not representations of a sequence of zeros or ones.

Microscopic pits formed in the surface of conventional “optical discs” are frequently arranged in tracks spaced radially from the center hub in a spiral track originating at the medium center hub and ending toward the medium's outer rim. The pitted side of the medium is conventionally coated with a reflectance layer such as a thin layer of aluminum or gold. The “pits” as seen from the metalized side, are also referred to “bumps” when referencing view from the laser-read side. A lacquer layer is typically coated on the pit side as a protective layer. The intensity of the light reflected from a read-only medium's surface measured by an optical reader varies according to the presence or absence of pits along the information track. When the readout spot is over a land, more light is reflected directly from the disc than when the readout spot is over a pit. As defect-induced errors may interfere with read, all optical discs employ error management strategies to eliminate the effect of such errors.

Publication WO 02/03386 A2 describes light-sensitive materials that are optical state change security materials that may be positioned with respect to a data deformation on an optical medium (“optical state change data deformations”) in a manner such that they do not adversely affect the data-read of the readout signal in one optical state but upon exposure to the wavelength of the optical reader incident beam covert to a second optical state, preferably in a time-delayed fashion, that do affect the data-read of the readout signal. One preferred optical state change security material that may be used in forming optical state change data deformations described in WO 02/03386 A2 is the “transient optical state change material” that causes a transient change in optical state of the material employed when the material is activated by the read out spot of an optical reader. Preferably the reversion time with respect to optical state for the transient optical state change material in a transient optical state change data deformation permits the optical reader upon a first read to detect the initial state, on a second read the changed optical state, and on a third read to detect the initial state once more. The transient optical state change reversion process preferably is such that the first read, second read and third read are sequential reads that occur with respect to one another in the shortest timeframe permitted by the read speed of the optical reader (that is, with respect to the location where the optical state change security material is located).

A transient optical state change security material may be, without limitation, a material that in response to a signal from the optical reader changes optical state so as to become more or less reflective, changes refractive index, emits electromagnetic radiation, changes in color, changes opacity, emits light (such as by, but not limited to, fluorescence or chemiluminescence) or changes the angle of any emitted wave from the transient optical state change security material in comparison to the angle of the incident signal from the optical reader. An optimal transient optical state change security material should be thermally and photochemically stable under conditions of optical use and at ambient conditions for a significant period of time. It should be soluble in a matrix that comprises the medium, or be capable of being adheredly-applied to the medium. An optimal transient optical state change security material should revert to its initial state without the need for extraneous inputs of energy, and should demonstrate a change in optical state at the incident wavelength of the optical reader. As would be understood by one of ordinary skill in the art, the read change at the locations where the transient optical state change security material is associated with the deformation may eventuate in the change of a valid data set read to a valid data set read, a valid data set read to an invalid data set read, an invalid data set read to a valid data set read, or an invalid data set read to an invalid data set read. As would further be understood by one of ordinary skill in the art, when a valid data set read to a valid data set read is effectuated, data can be compressed in a manner previously not permitted in the prior art. That is, judicious association of the transient optical state change security material with the optical deformations can be used to reduce the number of deformations necessary to produce a particular data read by permitting the same deformations to be used to store data in a manner consistent with its two read states.

As indicated in WO 02/03386 A2, transient optical state change data deformations may be used to authenticate an item by effectuation of a search for, and detection of, a transient optical state change on the optical medium at one or more pre-defined locations on the optical medium.

Transient optical state change data deformations are difficult to reproduce in that one needs to first identify the optical state change security material being used, then to identify the deformations (e.g., pits and lands) that are associated with the optical state change security material, and finally to exactingly apply such optical state change security material in a manner such that only the associated deformations are affected upon read by the optical reader that is to be employed. As indicated in WO 02/03386 A2, detection of the state change can, by means of software incorporated onto the medium or on the hardware used to read the medium, be used to effectuate employment of a desired action, such as the read of a program stored on an optical medium. Such software would limit activation of the action sought based on whether the transient optical state change is detected at a location where the state change is to occur.

Authentication of items other than optical discs with transient optical state change security materials in general, and by marking with optical state change data deformations in particular, would be advantageous. Given the difficulty in reproducing deformations employing transient optical state change security materials, and the ability of such deformations to be used to compact data owing to the ability of such deformations to have two data states, the present inventors have found it advantageous to employ such technology to provide for an improved authentication method that is useful to authenticate all sorts of items, including software and stored data structures.

There has been a considerable move towards storing personal data on semi-conductor integrated circuit (IC) cards. One use of currently available IC cards is to store monetary value thereon. A particular problem associated with certain IC cards used to store monetary value, the so-called “smart card,” is the liability of such cards to hacking. Hackers have been known to decapsulate the IC, and even to depassivate the upper protective layer, to either reverse engineer the chip or modify functions and confidential data contained thereon.

The operation of an IC card may be known and understood by deduction when the passivation layer covering the circuit is removed. For example, functional information can be deduced about an IC by observing the flow of current in the connections of the circuit with an electron microscope. Irradiation of the controller chip arrangement may bring it into a state in which more or less simple access to security-relevant data and/or functions is possible. The content of memory may discerned by analysis employing electro-optical potential probes. Data structure of a chip may also be accessed illicitly. Thus a major problem associated with so-called smart cards is the ability of dishonest persons to remove the semi-conducting chip from the card in order to examine it in an attempt to deduce its operation or neutralize its access codes.

In order to protect against the analysis of the components in an IC card, it has been proposed by many in the field to include light detection circuitry on the card which alters the operation of the IC when the passivation layer is removed (See, for example, U.S. Pat. Nos. 4,952,796 and 6,232,591). The problem with such circuitry is that it takes up much valuable semiconductor area. This is particularly disadvantageous in a smart card, where demand for space is at a premium.

Likewise, in order to protect against analysis of the data held within an IC card, various software-based systems have been employed. For example, many IC cards employ public key algorithms using certificates and encodings to protect data. The problem with such data protection algorithms is that they are often large and require excessive storage capacity. For example, in conjunction with the need to represent roles and allow distributed rather than centralized administration of certificates, the size of an end user's Public Key Infrastructure (PKI) key-ring often will exceed the storage capacity of even the largest smart card. Similarly biometric algorithms, used to limit access to data on the IC card to individuals having specified physical characteristics, are often extensive and require the storage of large amounts of data relating to the physical characteristics of an individual which are to be compared against (e.g., a fingerprint) those of the person seeking access. Information pertaining to a valid data structure may be interleaved with data pertaining to authentication of the data structure itself that may include algorithmic reference to a transient optical state change on a correlated item (e.g., the hard drive of a PC).

### Definitions

“Data Deformation”: a structural perturbation on or in an item that represents stored data and can be read by an optical reader.

“Optical Medium”: a medium of any geometric shape (not necessarily circular) that is capable of storing digital data that may be read by an optical reader.

J “Optical Reader”: a Reader (as defined below) for the reading of Optical Medium.

“Optical State Change Data Deformation”: refers to an optical deformation on an item representative of data that is associated with an Optical State Change Security Material in such a manner that the data read of the deformation by an optical reader changes with the optical state of the Optical State Change Security Material.

“Optical State Change Security Material”: refers to an inorganic or organic material used to authenticate, identify or protect an Optical Medium by changing optical state from a first optical state to a second optical state.

“Permanent Transient Optical State Change Security Material”: refers to a Transient Optical State Change Security Material that undergoes change in optical state for more than thirty times upon read of the Optical Medium by an Optical Reader.

“Reader”: any device capable of detecting data that has been recorded on an optical medium. By the term “reader” it is meant to include, without limitation, a player. Examples are CD and DVD readers.

“Read-only Optical Medium”: an Optical Medium that has digital data represented in a series of pits and lands.

“Recording Layer”: a section of an optical medium where the data is recorded for reading, playing or uploading to a computer. Such data may include software programs, software data, audio files and video files.

“Re-read”: reading a portion of the data recorded on a medium after it has been initially read.

“Transient Optical State Change Security Material”: refers to an inorganic or organic material used to authenticate, identify or protect an item by transiently changing optical state between a first optical state and a second optical state, and spontaneously reverting back to said first optical state after a period of time, and that may undergo such change in optical state more than one time upon read by an Optical Reader in a manner detectable by such Optical Reader.

“Transient Optical State Change Data Deformation”: refers to an optical deformation on an item representative of data that is associated with a Transient Optical State Change Security Material in such a manner that the data read of the deformation by an optical reader changes with the optical state of the Transient Optical State Change Security Material.

“Temporary Transient Optical State Change Security Material”: refers to a Transient Optical State Change Security Material that undergoes change in optical state for less than thirty times upon read of the Optical Medium by an Optical Reader.

For the purpose of the rest of the disclosure it is understood that the terms as defined above are intended whether such terms are in all initial cap, or not.

### SUMMARY OF THE INVENTION

The present invention provides for a method of authenticating items and objects associated with an item using optical state change security materials, and in particular transient optical state change security materials.

Transient optical state change security materials may be applied to items in association, or without association, with an optical data deformation on the item, or associated with the item, in order to provide an authentication technique for the item. The breadth of the disclosure goes to the authentication of any item by detecting a change in optical state in a position of the item, or item associated with such item, where such change is to occur. It has been found that the use of transient optical state change security materials in effectuating the state change greatly reduces the ability of others to mimic such state change using ersatz methods. Further, the present inventors have found association of such transient optical state change security materials with optical data deformations to form transient optical state change data deformations, provides for much more exacting structure for identifying authenticate items from items that have been altered in one or more fashions in that it is much more difficult to reproduce such transient optical state change data deformations than to simply apply in an exacting manner the transient optical state change security material to the correct positions on the item (or associated item). The difficultly in reproducing a transient optical state change data deformation on an item is even more difficult when the deformations are not of uniform dimension, e.g., pits of the same depth.

In one embodiment the present invention provides a method for authenticating items having optical deformations representative of data wherein one or more of the deformations is associated with a transient optical state security material such that the data read with respect to the deformation changes based on the optical state of the transient optical state security material.

In another embodiment, to increase the difficulty in replicating deformations in association with the transient optical state change security material, there are provided optical deformations comprising lands and pits, wherein the lands are nearly identical in height (so as to be read by the optical reader the same), while the pits are of at least two different depths, a first pit depth and a different second pit depth. Advantageously the difference between the first pit depth and second pit depth given the transient optical state change security material associated therewith is of such magnitude that an optical reader may read each pit at one time as an information pit, and at another time reading the information pits having a greater depth as other than an information pit, such as a land. For example the information pits of the first depth may be of the conventional depth of a read-only optical medium, that is, 0.2500, while the information pit depth of the different second depth may be 0.5000.

In a conventional read-only optical medium, the optical reader reads the information pits as dark, and the information lands as bright. With respect to the information pits of greater depth in such embodiment it may be a goal to allow such a conventional reader to read these pits once as dark and then a bright. It is noted that a key to a good reflected signal is the difference in depth between an information pit and an information land. Given the present disclosure, selection of pit depths would be obvious to one of ordinary skill in the art.

A transient optical state change data deformation that constitutes a pit that is of a different depth than other pits may be fabricated by a method comprising the steps of: (a) molding a substrate so as to have a first major surface with information pits and information lands thereon and a second major surface that is relatively planar, said information pits on said first major surface comprising information pits of two different depths; (b) applying a reflective material over the first major surface so as to cover said information pits and information lands; (c) removing the reflective material over said information pits of greater depth; and (d) applying a layer over said first major surface comprising an optical state change security material. The two depths of the information pits typically should be pre-selected taking into account the optical reader that will be used to read the deformation, and the optically-changeable security material.

The information pits in the fabricated optical medium may be read by a signal directed by said optical reader through the second major surface whether the optically-changeable security material is in a first optical state or a second optical state. Advantageously the two depths of said information pits differ by a factor such that the optical reader records any reflected signal from said optical medium, as adjudged by a difference between the depth of the information pits and height of the information lands, for example, differing by ¼ wavelength from the signal directed by the optical reader to the optical medium. Advantageously, the read of the optical reader is true to the physical structure of the information pits and the information lands when the optical state change security material is in one of its optical states but not in the other optical state. In one preferred embodiment, the two depths of the information pits differ by a factor of about 2.

The optical change in the optical state change security material must be detected by the optical read in the pickup with enough intensity to fool the optics, most preferably, into seeing a land instead of a pit. If a transient phase change in reflectivity is produced by the optical state change security material, then the reflectivity change would have to be operative. In one phase, the material should be highly reflective and the double depth (for example) information pits would be bright due to the specular (vs. diffuse) reflectivity of the material. In the other phase, the double depth pits (for example) would be dark due to the diffuse (vs. specular) reflection from the optical state change security material. Of course, the response of the “transient pits” (those of depth type having the optically-changeable security material readable by the optical reader) or, more generally, transient optical state change data deformations, would have to be reversed engineered through EFM demodulation, CIRC decoding, and Block decoding. Given the present disclosure, it is asserted that such would be in the purview of one of ordinary skill in the art.

In a particularly useful embodiment of the present invention, operation of an item, or read of the data thereon or therefrom, may be controlled by an authentication algorithm stored on/in the item or on/in an component associated with the optical reader, or the optical reader itself.

### BRIEF DESCRIPTION OF THE DRAWINGS

The accompanying drawings, which are incorporated in and constitute part of the specification, illustrate presently preferred embodiments of the invention, and together with the general description given above and the detailed description of the preferred embodiments given below, serve to explain the principles of the invention.

FIG. 1 illustrates an IC card with transient optical state change data deformations thereon.

### DETAILED DESCRIPTION OF THE INVENTION

The present invention provides for a authentication of items including physical objects, computer programming code, and data by detecting an optical state change on the item, or on an object associated (whether by programming code, physical connection, transmissible connection, or otherwise) with the item. The optical state change is effectuated by means of an optical state change security material that is positioned on the item, or the object associated with an item, in a known position. Evidence of the optical state change in the known position as characteristic of the optical state change security material used, is indicative of an authentic item. By application of appropriately written programs, authentication of the item by detection of such optical state change can be used to permit an activity associated with the item to be accessed or undertaken. For example, programming can be used to effectuate access to data to effectuate the transmission of data, and/or could be used to effectuate movement of, about, or within the item upon authentication of the item.

Particularly preferred optical state change security materials of the present invention are transient optical state change security materials, such materials provide an unexpectedly large deterrent to counterfeiting of items in that not only their placement with respect to the item, but also the time required in reverting back from an optical state change to the initial optical state, provide unique characteristics that can be used to judge the authenticity of an item. When such materials are associated with optical data deformations in a manner so as to alter the data read of an optical reader depending upon the optical state of the material, a particularly difficult structure to replicate is proffered to the would-be counterfeiter. A more insurmountable hurdle to the would be counterfeiter has been effectuated by including non-conventional optical deformations among conventional deformations in the optical data structure (for example, double depth pits vs. pits of conventional depth). By carefully controlling their associated relationship with the optical state change security material, optical state change data deformations can be designed to be read by an optical reader as optical data structure having two valid structure states (e.g., read both as a pit and land depending upon the state of the optical state change security material).

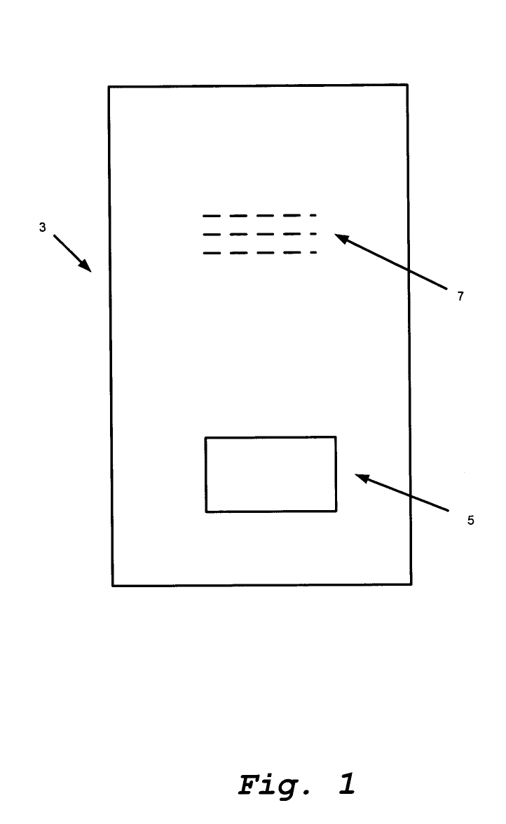

In one embodiment of the present invention, there is provided an IC card (3) having an IC (5) and optical deformations (7) as seen in FIG. 1. Preferably the IC card includes an optical state change security material, preferably a transient optical state change security material. In a preferred embodiment of the invention, there is provided an optical state change security material associated with optical state change data deformations in a manner to permit more than one data read by an optical reader of the optical data represented by the deformations depending upon the optical state of the optical state change material. When two optical states are effectuated by a read of a transient optical state change security material, one such optical state, for example, can present to the optical reader as a pit, while the second optical state may present as a land. The optical state change security material in association with, or not in association with, optical data deformations, may be located anywhere on or within the card, and may be located within the passivation layer of the IC such that depassivation of the IC would remove the authentication material and/or structure necessary for full activity of the IC. The IC can be programmed in a manner such that failure to locate the optical state change material (or more preferably a transient optical state change security material) at the correct location on or within the card, and/or on or within the passivation layer, can cause the IC chip to delete stored data and/or programming, alter its programming, transmit a signal upon use indicating that it the chip has likely been hacked, prevent transmission of signals from the card, prevent acceptance of digital data into the IC, or otherwise affect the functionality of the card reducing its usefulness to the would be hacker.

It has been found to be particularly useful to store data in optical deformations on an IC card so that the electronic information storage of the IC is reduced. It has been found particularly useful to store such information such as keys, biometric data, and other large algorithms in optical data structure rather than in the data storage units of the IC since the latter leaves greater room for electronic storage of information or programming that may be latter added to the card. When the deformations are optical state change data deformations, protection against duplication of the optical deformations is found to be greatly enhanced given the difficulty of not only detecting the particular optical state change security material being employed, but also in determining the data structure that is associated with such material. Significantly more protection is provided when the optical deformations comprise non-conventionally dimensioned deformations, as for example, when pits of conventional depth, and pits of extended depth (such as double depth pits) are employed in association with the optical state change security materials.

Storage of data in the optical state change data deformations of the present invention may provide significantly enhanced security over electronic storage of the same data in preventing exacting downloading of the information. The deformations may be so constructed to require complex decryption algorithms.

As transient optical state change data deformations may be used in conjunction with other deformations to store data in a manner such that two data reads (both of which may be valid for the particular optical reader) can be evinced from the same physical data structures, considerable data compression can be accomplished. That is, the optical state change data deformations may be used to effectuate a compression of data by being configured to provide complementary data sequences (CDSs) both of which are interpreted as valid.

In yet another embodiment of the present invention the transient optical state change security material is incorporated into the item to be authenticated and deep pits (bumps from the read side) flanking one or more lands molded into the item at predetermined locations. The pits may be constructed to be of such depth that as to form an interferometer between the enlarged bumps, when viewed from the read side, that fail to reflect sufficiently for read by the PUH of the optical reader when the material changes state due exposure to the incident read laser beam. This system therefore employs two components: the transient optical state change security material distributed throughout the material comprising the item (such as polycarbonate in an optical disc), and a interferometer, of the Fabry-Perot type (“FPI”). The deep pits act as the walls of the FPI, while the reflective land at the bottom acts as the primary reflective surface. By carefully selecting the transient optical phase change security material, under one set of conditions (intensity, wavelength, angle) there will be considerable reflectivity back to the source, while under a second set of conditions, there will be significantly less light reflected back to the source. These two states will be driven by the security material placed in the substrate comprising the item.

If the interferometer is appropriately manufactured, and the transient optical state change security material and substrate material chosen appropriately, the material in the item will be essentially transparent to the pick up head and all data will be read as one state. During the read, the material will absorb energy. When enough energy has been absorbed by the material its transmittance will decrease (less energy passes through) and it will cause a slight change in refractive index. In the second state with the transmittance decreased, if property designed, the input energy threshold for the FPI can be made to be crossed, and very little signal will be reflected. By carefully selecting the security material and its concentration in the substrate, one can cause enough signal to the optical data structures so as to be able to read such data. On the other hand, if RI is changed when the material is activated by the read beam, the security material and its concentration, and the depths of the pits (from the non-read side) should be such as to result in a change in wavelength that crosses the FPI threshold resulting in a reduction in reflectivity, but the wavelength change should be small enough that normal sized optical data structures may still be resolved.

### Statement Regarding Preferred Embodiments

While the invention has been described with respect to preferred embodiments, those skilled in the art will readily appreciate that various changes and/or modifications can be made to the invention without departing from the spirit or scope of the invention as defined by the appended claims. All documents cited herein are incorporated in their entirety herein.

1. An IC card comprising a substrate, said substrate having a semiconductor integrated circuit and one or more optical data deformations incorporated therein that are representative of digital data.

2. The IC card of claim 1 wherein one or more of said optical deformations are associated with a optical state change security material.

3. The IC card of claim 2 wherein the optical state change security material is a transient optical state change security material.

4. The IC card of claim 3 wherein the transient optical state change material is associated with the optical data deformations in such a manner as to provide two optical data reads when the optical data deformations are read by an optical reader.

5. The IC card of claim 4 wherein each of the optical data reads is indicative of valid data.

6. The IC card of claim 4 wherein one optical data read is indicative of valid data, while the other optical data read is indicative of invalid data.

7. The IC card of claim 4 wherein each of the optical data reads in invalid.

8. The IC card of claim 4 wherein the optical data deformations comprise pits and lands.

9. The IC card of claim 8 wherein said pits comprise pits of two distinctly different depths.

10. The IC card of claim 8 wherein one or more pits acts as a Fabry-Perot type interferometers.

11. A method for authenticating an item comprising the steps of: (a) detecting on an item, or an substrate associated with the item, a transient optical state change material, (b) determining the locations where which such materials are located on the authentic item, or substrate associated with the item, and (c) declaring the item as authentic when such detection occurs and the transient optical state change material is found at the same locations as an authentic item.

12. The method of claim 11 wherein the transient optical state change material is associated with an optical data deformation in a manner to change the optical read of such deformation between two or more states when such deformations are read by an optical reader.
